(19) United States
(12) Patent Application Publication
(10) Pub. No.: US 2017/0147091 A1
(43) Pub. Date: May 25, 2017

(54) LIGHT GUIDE DEVICE AND MOUSE

(71) Applicant: HON HAI PRECISION INDUSTRY CO., LTD., New Taipei (TW)

(72) Inventor: PO-YU LIN, New Taipei (TW)

(21) Appl. No.: 14/980,684

(22) Filed: Dec. 28, 2015

(30) Foreign Application Priority Data
Nov. 20, 2015 (TW) 104138374

(51) Int. Cl. G06F 3/03; G06F 3/0354

(52) U.S. Cl. CPC G06F 3/0317; G06F 3/03543

(57) ABSTRACT

A light guide device includes a main body defining a cavity, a lens received in the cavity, and a light guide block extending from the main body. The main body has a top surface and a peripheral side surface connecting the top surface. The light guide block extends from the peripheral side surface in a form of a curve along a direction from a position of the peripheral side surface adjacent to the top surface towards an end of the main body opposite to the top surface. The light guide block curves away from the peripheral side surface along the direction. The light guide block has an incident surface parallel to the top surface and a plurality of side surfaces connecting the incident surface and the peripheral side surface.

### FIELD

The subject matter herein generally relates to a light guide device and a mouse using the light guide device.

### BACKGROUND

An optical mouse usually comprises a shell, a light source, and an optical guide device. The light source and the optical guide device are both mounted in the shell. The optical guide device is configured for guiding light rays from the light source to a working surface (such as a surface of a desk or a mouse pad).

### BRIEF DESCRIPTION OF THE DRAWINGS

Implementations of the present technology will now be described, by way of example only, with reference to the attached figures.

FIG. 1 is an isometric view of an exemplary embodiment of a light guide device.

FIG. 2 is an isometric view of the light guide device of FIG. 1, but viewed from another angle.

FIG. 3 is a cross-sectional view of FIG. 1 along line III-III.

FIG. 4 is an isometric view of the light guide device of FIG. 1, but viewed from another angle.

FIG. 5 is a cross-sectional view of an exemplary embodiment of a mouse.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series, and the like.

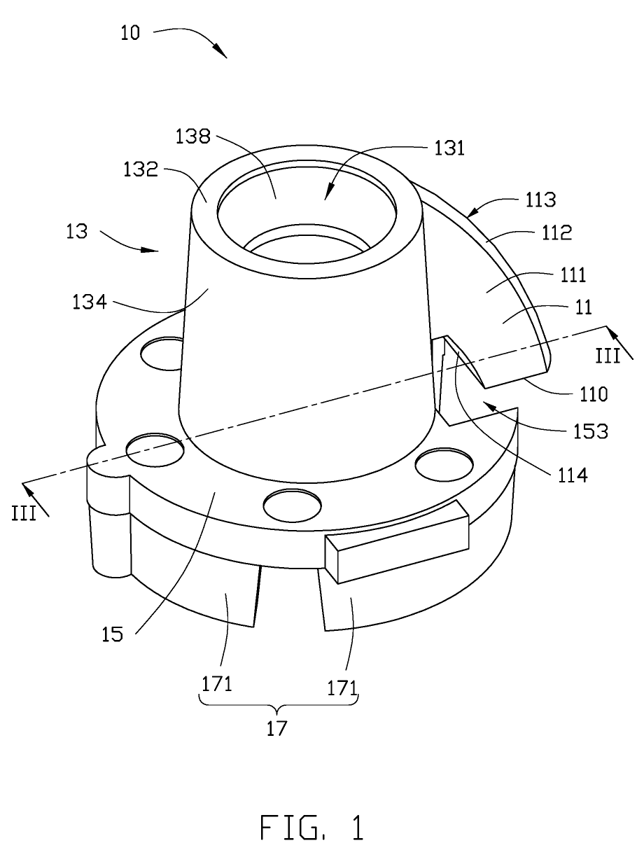

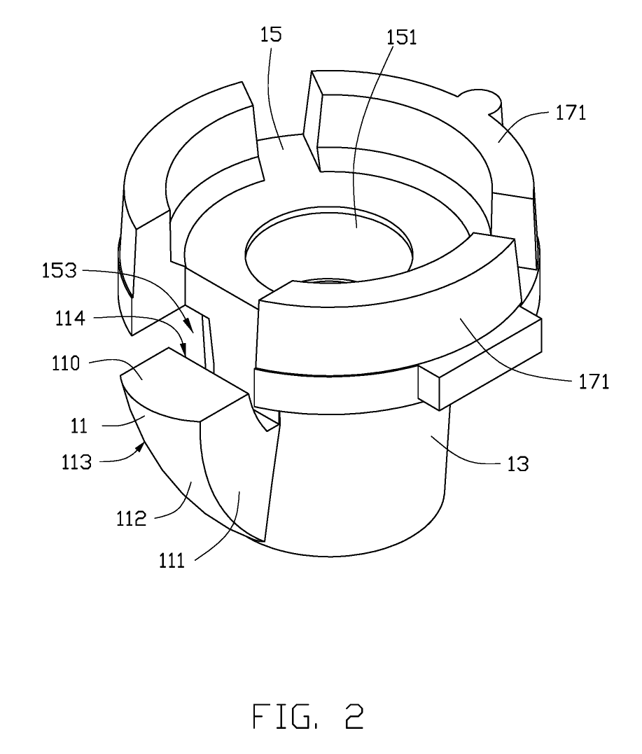

FIGS. 1 and 2 illustrate a light guide device 10 according to an exemplary embodiment. The light guide device 10 is used in a computer mouse, especially in an optical mouse. The light guide device 10 is made of light guide material. The light guide device 10 comprises a main body 13 and a light guide block 11 extending from the main body 13. In at least one embodiment, the light guide block 11 and the main body 13 are made of a same transparent material and are integrally formed together. In at least one embodiment, the main body 13 is substantially frustoconical shaped. The main body 13 includes a top surface 132 and a peripheral side surface 134 coupled to the top surface 132. The peripheral side surface 134 is a substantially curved surface. The main body 13 defines a cavity 131 through the main body 13. The cavity 131 is defined through the top surface 132.

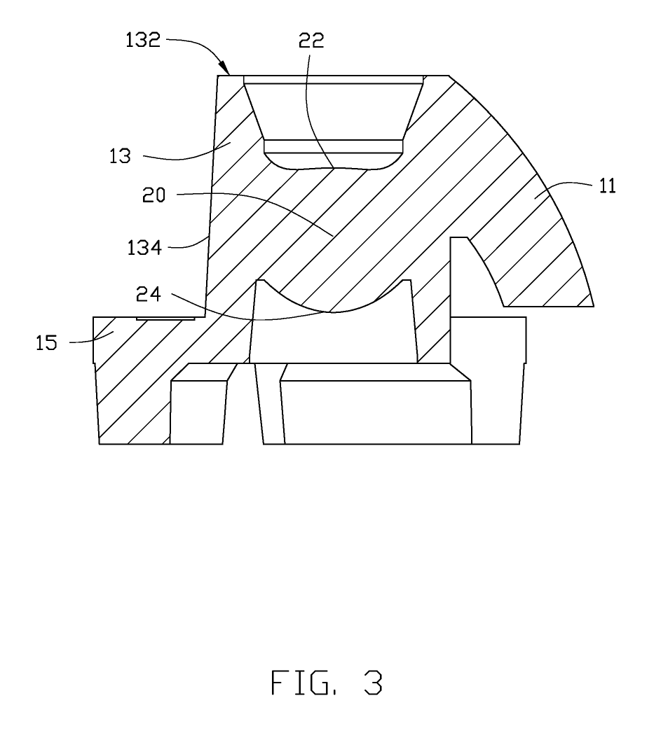

FIG. 3 illustrates the light guide device 10 further comprises a lens 20 received in the cavity 131. The lens 20 is a convex lens to focus light rays. The lens 20 has an upper surface 22 and a lower surface 24 on a side opposite to the upper surface 22, wherein the upper surface 22 is adjacent to the top surface 132. In at least one embodiment, the lens 20 and the main body 13 are made of a same transparent material and are integrally formed together. In other embodiments, the lens 20 and the main body 13 are separately formed, and the lens 20 is coupled to the main body 13 by adhesive.

The light guide block 11 is configured for guiding light rays from a light source (not shown) into the light guide device 10. The light guide block 11 is shaped like a curved block. The light guide block 11 extends from the peripheral side surface 134 in a form of a curve along a direction from a position of the peripheral side surface 134 adjacent to the top surface 132 towards an end (not shown) of the main body 13 opposite to the top surface 132, and curves away from the peripheral side surface 134 along the direction. The light guide block 11 has an incident surface 110 substantially parallel to the top surface 132 and a plurality of side surfaces connecting the incident surface 110 and the peripheral side surface 134. The incident surface 110 is an end surface of the light guide block 11 away from the main body 13.

In one embodiment, there are four side surfaces that are a first side surface 111, a second side surface 112, a third side surface 113, and a fourth side surface 114. The first side surface 111, the second side surface 112, the third side surface 113, and the fourth side surface 114 are connected in sequence. The first side surface 111, the second side surface 112, the third side surface 113, and the fourth side surface 114 extend from the peripheral side surface 134 and extend along a direction away from the peripheral side surface 134, respectively. The second side surface 112 and the fourth side surface 114 are two opposite curved surfaces, and the second side surface 112 has a larger size than the fourth side surface 114. The first side surface 111 and the third side surface 113 are two opposite flat surfaces.

The main body 13 has an inner surface 138 around the cavity 131. Area of the inner surface 138 between the lens 20 and the top surface 132 is a total reflection surface. The first side surface 111, the second side surface 112, the third side surface 113, and the fourth side surface 114 are also total reflection surfaces.

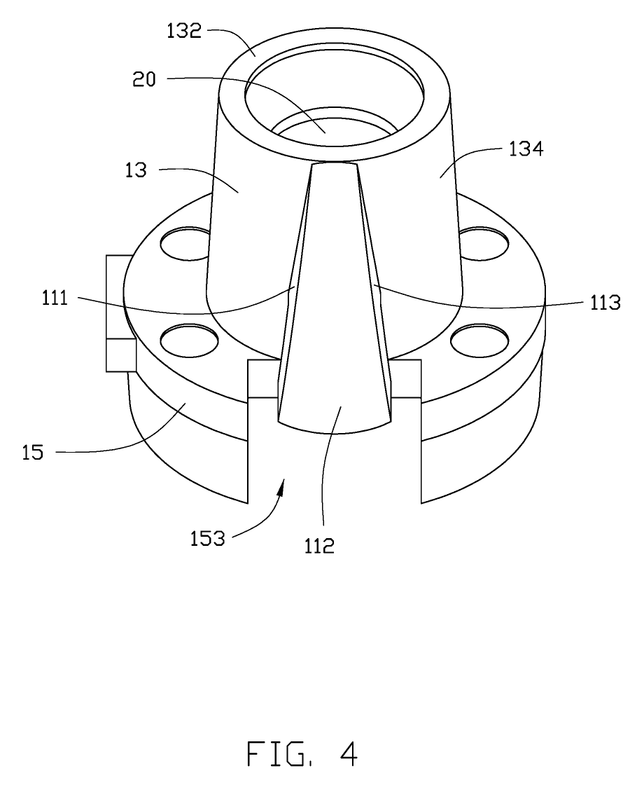

FIG. 4 shows that the second side surface 112 gradually broadens along its extending direction from the peripheral side surface 134 to the incident surface 110. The fourth side surface 114 also gradually broadens along its extending direction from the peripheral side surface 134 to the incident surface 110, although the fourth side surface 114 cannot be directly viewed in the FIG. 4. That is, the first side surface 111 and the third side surface 113 are not parallel to each other, and neither the first side surface 111 nor the third side surface 113 are perpendicular to the incident surface 110.

The light guide device 10 further comprises a base 15 coupled to the end (not shown) of the main body 13 opposite to the top surface 132. In one embodiment, the base 15 has a shape of circular plate. The base 15 defines a through hole 151 aligned and communicating with the cavity 131 and a gap 153 facing the incident surface 110.

The light guide device 10 further comprises an engaging portion 17 coupling to the base 15 opposite to the main body 13. The engaging portion 17 is configured to engage with an optical sensor (not shown). In at least one embodiment, the engaging portion 17 comprises a plurality of engaging blocks 171.

In at least one embodiment, the light guide block 11, the main body 13, the lens 20, the base 15, and the engaging portion 17 are all made of a same transparent plastic (such as polymethylmethacrylate or polycarbonate) and are integrally formed.

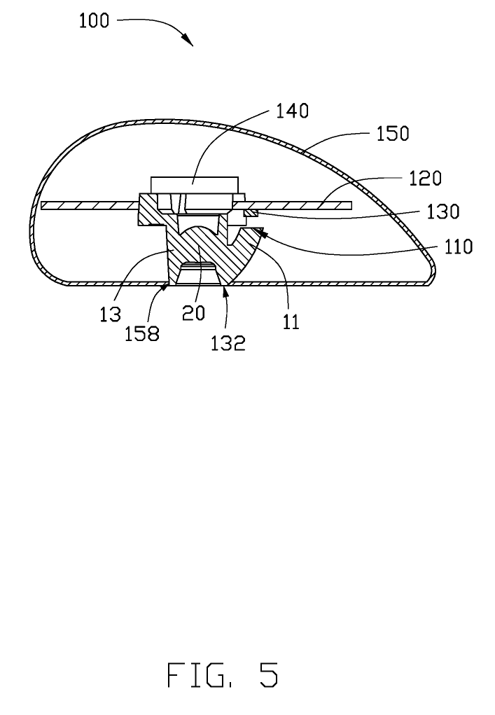

FIG. 5 illustrates a mouse 100 using the light guide device 10 according to an exemplary embodiment. The mouse 100 comprises a shell 150, a printed circuit board (PCB) 120, a light source 130, and an optical sensor 140. The PCB 120, the light source 130, and the optical sensor 140 are received in the shell 150. The light source 130 may be a light emitting diode light.

The shell 150 defines an opening 158, and the top surface 132 of the main body 13 is positioned in the opening 158. The optical sensor 140 is engaged in the engaging portion 17. The light source 130 is mounted on the PCB 120 and positioned in the gap 153, thus, the light source 130 faces the incident surface 110.

Light rays from the light source 130 enter in the light guide device 10 via the incident surface 110, a portion of the lights rays propagate through the light guide block 11 and the main body 13 to the working surface (not shown, such as a surface of a desk or a mouse pad), then light rays are reflected by the working surface and pass through the lens 20, light rays are focused by the lens 20 and pass through the cavity 131 and the through hole 151, and finally reach the optical sensor 140 and are received by the optical sensor 140.

Optical axis of light rays passing through the light guide block 11 to the working surface and optical principal axis of the lens 20 form an angle of less than 10 degrees. Thus, light rays guided by using the light guide device 10 are more concentrated. Tolerance (distance between bottom of the shell 150 having the opening 158 and the working surface) can be improved. The light guide device 10 can be used to guide light having a wavelength of about 400 to 750 nm.

The second side surface 112 and the fourth side surface 114 gradually broaden along their extending direction from the peripheral side surface 134 to the incident surface 110. Thus, a portion of light rays from the light source 130 may directly reach the working surface by propagating parallel to the second side surface 112 or the fourth side surface 114.

It is believed that the exemplary embodiment and its advantages will be understood from the foregoing description, and it will be apparent that various changes may be made thereto without departing from the scope of the disclosure or sacrificing all of its advantages, the examples hereinbefore described merely being preferred or exemplary embodiments of the disclosure.

What is claimed is:

1. A light guide device, comprising:
a main body having a top surface and a peripheral side surface coupled to the top surface, the main body defining a cavity that extends through the main body and the top surface;
a lens received in the cavity; and
a light guide block extending from the peripheral side surface in a form of a curve along a direction from a position of the peripheral side surface adjacent to the top surface towards an end of the main body opposite to the top surface;
wherein the light guide block curves away from the peripheral side surface along the direction and has an incident surface parallel to the top surface and a plurality of side surfaces connecting the incident surface and the peripheral side surface.

2. The light guide device as claimed in claim 1, wherein each of the plurality of side surfaces extends from the peripheral side surface and along a direction away from the peripheral side surface, the plurality of side surfaces comprises a first side surface, a second side surface, a third side surface, and a fourth side surface, the second side surface and the fourth side surface are two opposite curved surfaces, the first side surface and the third side surface are two opposite flat surfaces.

3. The light guide device as claimed in claim 2, wherein the second side surface gradually broadens along its extending direction from the peripheral side surface to the incident surface; the fourth side surface gradually broadens along its extending direction from the peripheral side surface to the incident surface.

4. The light guide device as claimed in claim 1, wherein the peripheral side surface and the plurality of side surfaces are total reflection surfaces.

5. The light guide device as claimed in claim 1, wherein the main body has an inner surface around the cavity, area of the inner surface between the lens and the top surface is a total reflection surface.

6. The light guide device as claimed in claim 1, wherein the peripheral side surface is a curved surface.

7. The light guide device as claimed in claim 1, wherein the light guide device further comprises a base coupled to an end of the main body opposite to the top surface, the base defines a through hole aligned and air communicating with the cavity and a gap facing the incident surface.

8. The light guide device as claimed in claim 1, wherein the light guide device further comprises an engaging portion coupled to the base opposite to the main body.

9. The light guide device as claimed in claim 1, wherein the light guide device is made of transparent material.

10. A mouse comprising:
a shell defining an opening; and
a printed circuit board, a light source, an optical sensor, and a light guide device in the shell;
the light guide device, comprising:
a main body having a top surface and a peripheral side surface coupled to the top surface, the main body defining a cavity that extends through the main body and the top surface;
a lens received in the cavity; and
a light guide block extending from the peripheral side surface in a form of a curve along a direction from a position of the peripheral side surface adjacent to the top surface towards an end of the main body opposite to the top surface;
wherein the light guide block curves away from the peripheral side surface along the direction and has an incident surface parallel to the top surface and a plurality of side surfaces connecting the incident surface and the peripheral side surface.

11. The mouse as claimed in claim 10, wherein the top surface of the main body is positioned in the opening; the light source is mounted on the printed circuit board and faces the incident surface.

12. The mouse as claimed in claim 10, wherein each of the plurality of side surfaces extends from the peripheral side surface and along a direction away from the peripheral side surface, the plurality of side surfaces comprises first a side surface, a second side surface, a third side surface, and a fourth side surface, the second side surface and the fourth side surface are two opposite curved surfaces, and the second side surface has a larger size than the fourth side surface, the first side surface and the third side surface are two opposite flat surfaces.

13. The mouse as claimed in claim 12, wherein the second side surface gradually broadens along its extending direction from the peripheral side surface to the incident surface; the fourth side surface gradually broadens along its extending direction from the peripheral side surface to the incident surface.

14. The mouse as claimed in claim 10, wherein the light guide device further comprises a base coupled to an end of the main body opposite to the top surface, the base defines a through hole aligned and air communicating with the cavity and a gap facing the incident surface, the light source is positioned in the gap.

15. The mouse as claimed in claim 10, wherein the light guide device further comprises an engaging portion coupled to the base opposite to the main body, the optical sensor is engaged in the engaging portion.

16. The mouse as claimed in claim 10, wherein the light guide device is made of transparent material.

17. The mouse as claimed in claim 10, wherein the peripheral side surface is a curved surface.

18. The mouse as claimed in claim 10, wherein the peripheral side surface and the plurality of side surfaces are total reflection surfaces; the main body has an inner surface around the cavity, area of the inner surface between the lens and the top surface is a total reflection surface.
